(19) United States
(12) Patent Application Publication
(10) Pub. No.: US 2004/0045659 A1
(43) Pub. Date: Mar. 11, 2004

(54) Electrostatic powder coating method using electrostatic powder transfer and electrostatic powder coating apparatus realizing said method

(76) Inventor: Maresuke Kobayashi, Narashino (JP)

Correspondence Address: Maresuke KobayashiI, 210 Sodegaura 2-3-1, Narashino, CHIBA, JP

(21) Appl. No.: 10/237,278

(22) Filed: Sep. 9, 2002

(51) Int. Cl. B05D 1/12; B05D 1/04; B44C 1/165

(52) U.S. Cl. 156/230; 427/475; 427/180; 156/540; 156/279

(57) ABSTRACT

The object of the present invention is to allow powder coating to be performed even on objects having shapes for which powder coating had conventionally been difficult or impossible.

In the present invention, after temporarily adhering a powder to an intermediate object by static electricity, the powder adhered to the intermediate object is coated onto a target object to be coated by transferring that powder. External initial jumping energy, or transfer energy, is imparted to the powder adhered to the intermediate object using, for example, a mechanical vibrator, scraper, air purging device using as little air as possible or acoustic vibrator, corresponding to the shape of the object to be coated.

### TECHNICAL FIELD

The present invention relates to an electrostatic powder coating method and an electrostatic powder coating apparatus using electrostatic powder transfer which are effective for coating objects having a shape that made coating difficult or impossible as a result of using air for the powder transport means and dispersion means in an electrostatic powder coating method of the prior art, and which are effective for coating objects having a shape that prevents the obtaining of a proper electrostatic field due to the occurrence of insulation breakdown of the air when a gun type of ordinary electrostatic powder coating device is brought in close proximity, and the resulting sparking causing the powder to become charged. Furthermore, the present application has been filed claiming priority from Japanese Patent Application No. 2000-302896.

### BACKGROUND ART

In electrostatic powder coating, an electrostatic field is formed between an object to be coated and a coating device, a powder is fed into that space with air, and that powder is sprayed onto the object to be coated to coat the object. Alternatively, a powder is passed through a pipe conduit of a coating device, and after the powder is charged due to friction with the wall of this conduit pipe, it is sprayed onto an object to be coated to coat the object. Moreover, instead of charged powder particles, a large number of electrons created with a high-voltage electric field are fed onto an object to be coated, and the opposite polar charge that gathers by electrostatic induction on the surface of the object to be coated is weakened.

In the coating of the inner surface of a pipe using the above electrostatic powder coating methods, since the nozzle of the coating device must be inserted inside the pipe, only pipes having a diameter larger than the size of the nozzle were able to be coated. Moreover, since a large amount of air is consumed to feed in the powder, even if the nozzle was able to be inserted, the air after having carried the powder reaches a high speed as a result of having been forced to pass through an extremely narrow escape path, thereby resulting in the problem of blowing off not only the powder attempting to adhere to the pipe, but also the powder that has already adhered to the inner surface of the pipe. The heretofore failure of powder to adhere to concave corners, due to the dissipation of the electric field caused by the Faraday Cage phenomenon, has been determined to be the cause of this blowing off of the powder in nearly all cases. In addition, in the case of electrostatic powder coating in which a high-voltage electric field is applied inside a small diameter pipe, namely a narrow space, sparking occurred as a result of inducing insulation breakdown of the air, which in turn ignited the powder and caused a small-scale dust explosion. Thus, the object of the present invention is to solve problems like those described above.

Furthermore, even in the case of medium and large diameter pipes, it was necessary to rotate the pipe in order to obtain a uniform film thickness in the direct coating method of the prior art. However, since powder that did not adhere fell down and accumulated below, and further wore off even the layer of adhered powder by rotation, the pipe had to be preheated to melt the powder immediately and adhere it to the pipe. This meant that the gun had to be cooled while also resulting in extreme soiling of the nozzle as well as the occurrence of various other secondary problems. In addition, a spiral striped pattern frequently formed in the coated film due to the relationship between the rotating speed of the pipe, movement speed of the gun and the amount of the powder sprayed, thereby lowering the flow characteristics of the pipe. Furthermore, there were also cases in which powder that lacked the ability or had severely impaired ability to become charged for some reason was mixed into the powder itself.

### DISCLOSURE OF THE INVENTION

The above problems are resolved by temporarily adhering powder onto an intermediate object to be coated by static electricity, and then coating the powder onto the target object to be coated by transferring the powder adhered to this intermediate object. Namely, in the case of, for example, coating the inside of a pipe, powder should first be adhered to an intermediate object that can be inserted into the pipe, this intermediate object should be inserted into the pipe, and the powder should then be transferred from the intermediate object to the inside of the pipe. Thus, since the coating powder temporarily adhered to the intermediate object can be transferred to the target object to be coated by transfer without using or hardly using any air, it is not necessary to disperse the powder with a large amount of air, and the negative action of the powder being blown off by air is eliminated. In addition, safety is enhanced since there is no longer any need to apply a high voltage as in the case of the electrostatic powder coating as described above. In this manner, powder coating can be performed on the inner surface of a small diameter pipe. In addition, powder coating using electrostatic adhesion can also be performed reliably even on the narrow slits of, for example, the rotor of a motor, while also enabling a certain degree of targeted, localized coating, thereby reducing the degree of soiling of those locations that are not desired to be coated.

Furthermore, according to the present invention, secondary effects are generated consisting of enabling cold coating, eliminating the need for rotation, improving the coating speed, and eliminating the appearance of a striped pattern. This means that, if the present invention is used for electrostatic powder coating of objects having an ordinary shape, soiling of the hanger and so forth can be reduced, and the management burden of the coating line can be improved. In addition, according to the present invention, since the powder temporarily adhered to the intermediate object consists entirely of that having the ability to be electrostatically adhered, powder can be selected that has the ability to be electrostatically adhered, thereby resulting in satisfactory coating efficiency and uniform thickness of the coated film as compared with direct coating methods. In particular, the problem of powder falling down as a result of not having adhesive ability and wearing away other powder that has already been adhered, as is seen in direct coating methods, can be suppressed.

However, even if a voltage of the same polarity as the charge applied to the powder and the same level of potential as that during coating is applied to the intermediate object in anticipation of electrostatic repulsion, the powder adhered to the intermediate object was proven to hardly move at all. In addition, once the powder is adhered to the intermediate object by electrostatic charging, it immediately begins to discharge its own electrostatic charge into the air. Although there is hardly any occurrence of powder that has lost its charge-in this manner falling due to its own weight, it gradually loses its ability to transfer with the passage of time. Therefore, external initial jumping energy, or transfer energy, should be applied to the powder adhered to the above intermediate object as quickly as possible. For example, a mechanical vibrator, scraper, air purging device using as little air as possible or acoustic vibrator should be used corresponding to the shape of the object to be coated. Transfer efficiency is improved by the use of any of these means as well.

Furthermore, although the above discharge is influenced by the physical properties of the powder itself and ambient temperature and humidity conditions, since conditions for transfer are more favorable while the powder retains its electrostatic charge, in practical terms, it turned out in the present invention that transfer efficiency decreases unless transfer takes place within several tens of seconds to several minutes. In addition, there are also cases in which the particles that have jumped are affected by the electric fields created by other particles, causing them to return due to rebound. Therefore, in order to enhance transfer efficiency, it is preferable to apply a potential of the same polarity as the polarity of the charged particles (powder) to the intermediate object. Namely, a comparatively low potential electric field is applied between the intermediate object and target object to be coated. Since the purpose of the application of this electric field is to inhibit the return of particles due to electrostatic repulsion and not for applying an additional charge to the particles, a voltage of 100 V to several kV is sufficient.

A gap is required for transfer in electrostatic powder coating. Although the distance gap of transfer is influenced by the physical properties of the powder, the amount of charge, particle size, temperature and humidity conditions of the ambient air and the auxiliary applied voltage, etc., in the case of ordinary powders, a gap of 10 mm or less, and when considering transfer efficiency, about several mm, is optimum in practical terms. However, the present invention is not necessarily limited to this.

### BRIEF DESCRIPTION OF THE DRAWINGS

FIG. 1 is a schematic drawing of electrostatic powder coating of a first embodiment of the present invention for coating a plate-shaped object using a scraper.

FIG. 2 is a schematic drawing of electrostatic powder coating of a second embodiment of the present invention for coating the inside of a pipe using a scraper.

FIG. 3 is a schematic drawing of electrostatic powder coating of a third embodiment of the present invention for coating the rotor slits of a motor using a scraper.

FIG. 4 is a schematic drawing of a transfer energy activator of a fourth embodiment of the present invention that imparts transfer energy by impact vibrations.

FIG. 5 is a schematic drawing of a transfer energy activator of a fifth embodiment of the present invention that-imparts transfer energy by acoustic vibrations.

FIG. 6 is a schematic drawing of a transfer energy activator of a sixth embodiment of the present invention that imparts transfer energy by applying impact vibrations to a thin wire 18.

FIG. 7 is a schematic drawing of a transfer energy activator of a seventh embodiment of the present invention that imparts transfer energy by scraping using a variation of an intermediate object.

FIG. 8 is a schematic drawing of a transfer energy activator of an eighth embodiment of the present invention that imparts transfer energy by air purging.

### BEST MODE FOR CARRYING OUT THE INVENTION

Although the following provides an explanation of the embodiments of the present invention with reference to the attached drawings, the present invention is not limited to these embodiments only.

Embodiment 1

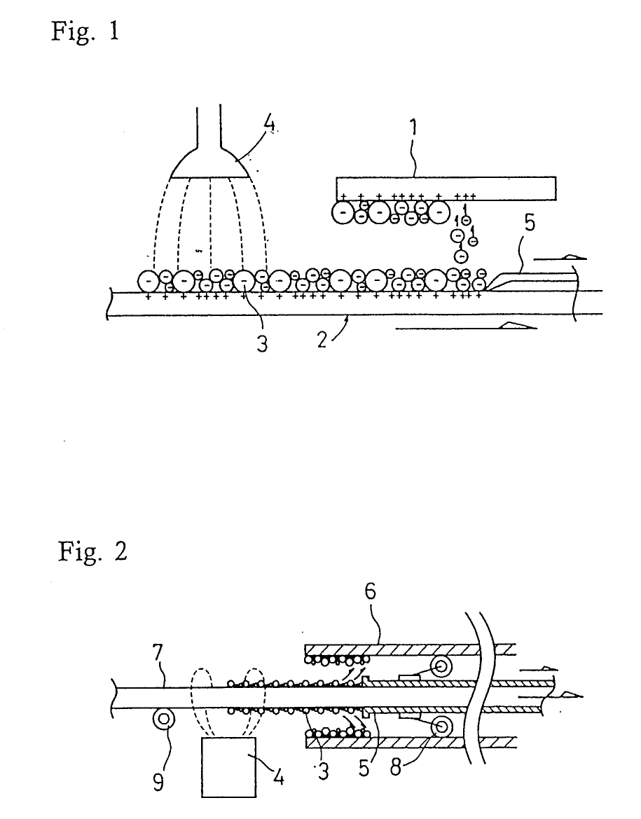

FIG. 1 is a schematic drawing of electrostatic powder coating of the present embodiment. Powder 3 adhered to intermediate object 2 is scraped from intermediate object 2 by a mechanical scraper 5 (knife-shaped object) resulting in transfer to and coating of a target object to be coated 1. Here, target object to be coated 1 is fixed, and intermediate object 2 slides while causing powder 3 to transfer to the uncoated surface of target object to be coated 1. The above scraper 5 moves at a speed slower than intermediate object 2 and in the same direction as intermediate object 2. Depending on the type of powder 3, an electrostatically induced electric field is formed by the charge possessed by powder 3 alone, enabling the powder 3 to be transferred easily as a result of charge of the opposite polarity gathering on the surface of target object to be coated 1. Furthermore, although the above scraper 5 eliminates the electrostatic binding force of powder 3 with respect to intermediate object 2, coated powder 3 may also be rebounded by making contact with target object to be coated 1 or return due to colliding with other powder particles of powder 3, causing it to be re-adhered to intermediate object 2. Therefore, in order to enhance transfer efficiency, re-adherence may be prevented by applying a slight potential difference between intermediate object 2 and target object to be coated 1. Furthermore, reference symbol 4 indicates an electrostatic powder coating device that supplies powder 3. Moreover, a design may also be employed wherein intermediate object 2 is fixed while target object to be coated 1 is moved with scraper 5.

Embodiment 2

Although the above Embodiment 1 related to electrostatic powder coating that utilized transfer to a plate-shaped target object to be coated 1, the present Embodiment 2 relates to coating the inner surface of a pipe. A pipe-shaped intermediate object 7 is prepared having a narrow diameter on the order of several mm to several tens of mm that is narrower than the inner diameter of a target object to be coated 6 in the form of a pipe, the inner surface of which is desired to be coated. After then aligning the centers of both pipes, intermediate object 7 is set so as to be able to be inserted into target object to be coated 6. Powder 3 is then temporarily adhered to intermediate object 7 by electrostatic powder coating device 4 outside the opening of the pipe of target article to be coated 6. While intermediate object 7 is moved inside target object to be coated 6 with charged powder in the form of powder 3 adhered to its outer peripheral surface, the charged and adhered powder is transferred from the surface of intermediate object 7 by pipe-shaped scraper 5 that tightly covers intermediate object 7, resulting in transfer of powder 3 to the inner surface of target object to be coated 6. Here, although target object to be coated 6 is fixed, a constant amount of powder 3 is scraped off provided the movement speed of scraper 5 is slower than the movement speed of intermediate object 7. Thus, the amount of adhered powder can be regulated by the movement speed of intermediate object 7, the movement speed of scraper 5, and the coating ability of electrostatic powder coating device 4. Furthermore, reference symbol 8 indicates a centering apparatus that uses rollers which roll over the inner wall surface of target object to be coated 6, while reference symbol 9 indicates an external pipe support member that supports intermediate object 7 with a roller.

Embodiment 3

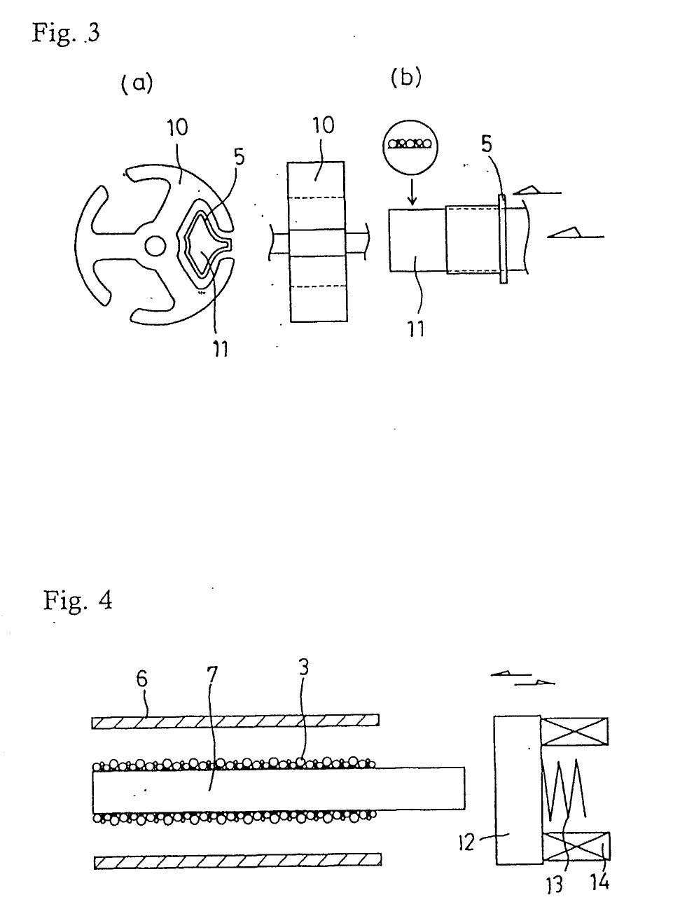

The present embodiment relates to electrostatic powder coating for coating the rotor slits of a motor. Although the narrow space between the rotor and stator of a motor frequently requires powder coating for electrical insulation of the coils, due to the formation of so-called Faraday cages, an electric field is not formed in the slits. Thus, in the case of spraying powder from the outside, normal electrostatic powder coating is difficult, and there is frequent occurrence of the “blow-off” effect in which the powder is blown off the object to be coated. In addition, if powder adheres to portions such as outer peripheral portions that are not desired to be coated, additional work is required to remove that powder. Therefore, in the example of coating the rotor slits of a motor of FIG. 3, powder is first adhered to intermediate object 11 that has a similar cross-section to this rotor slit and smaller dimensions to form a constant gap with the surface of the rotor slit. Intermediate object 11 is then inserted into a slit of motor rotor 10, and by transferring powder 3 to the slit of motor rotor 10 with scraper 5 while sliding intermediate object 11, the desired locations to be coated can be coated.

Embodiment 4

The present embodiment relates to electrostatic powder coating for transfer and coating by applying mechanical vibrations to an intermediate object. Each particle of the powder is presumed to be on the nanogram order based on a simple calculation of particle size and specific gravity. Since electrostatic force acts relatively strongly when mass is of this order, sufficient transfer energy cannot be imparted with weak vibrations. Thus, it is necessary to apply impact vibrations, high-pitch acoustic vibrations or high-frequency vibrations such as ultrasonic vibrations in order to overcome the relatively strong electrostatic force. FIG. 4 shows an example of a transfer energy activator that imparts transfers energy to charged particles by vibrations, and particularly impact vibrations. In addition to attaching electromagnet 14 to a weight in the form of hammer 12, coil spring 13 is attached for returning to the original state so as to be composed so that hammer 12 is able to make contact with intermediate object 7. Namely, after intermediate object 7, to which powder has been electrostatically adhered, is inserted into target object to be coated 6, impacts are applied by the above hammer 12. As a result, charged powder 3 adhered to intermediate object 7 can be transferred from intermediate object 7.

Embodiment 5

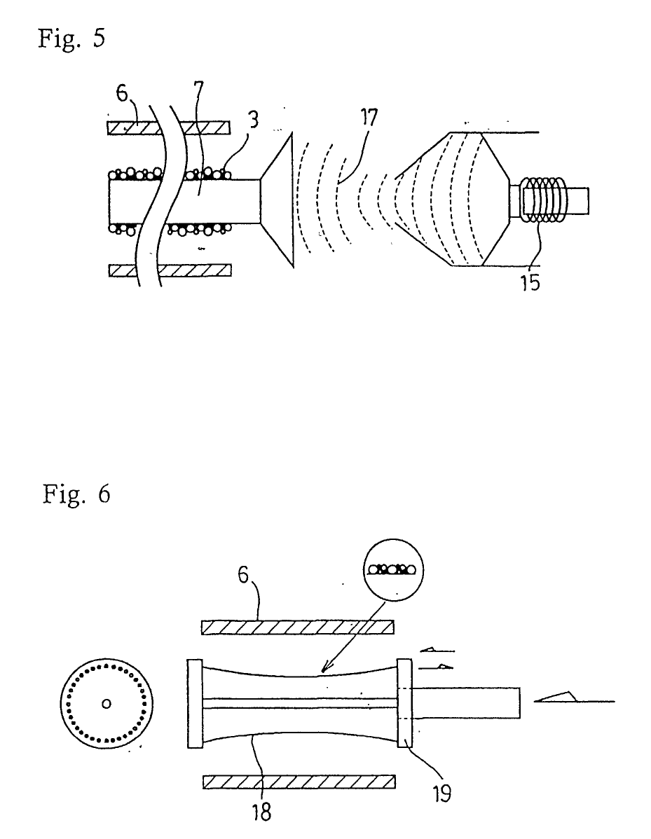

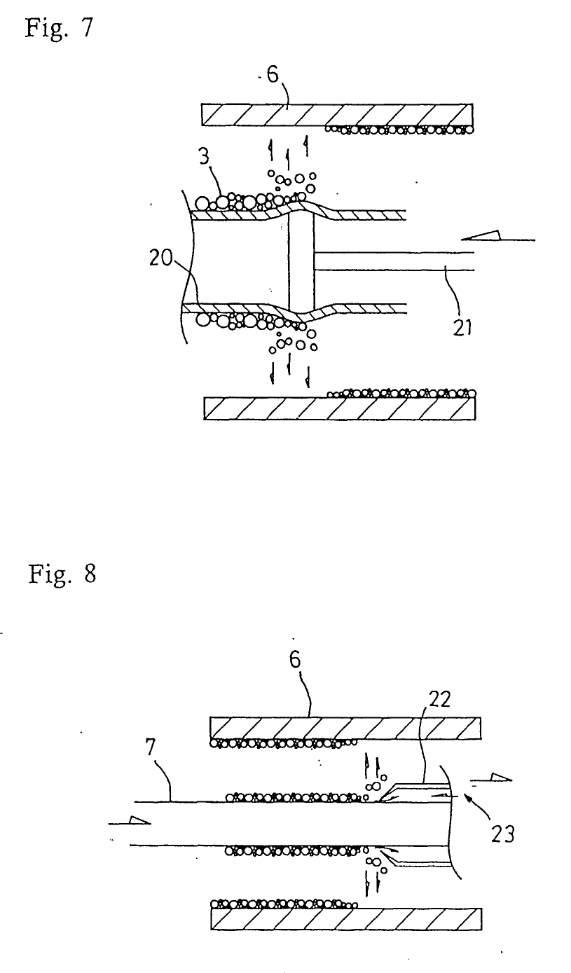

FIG. 5 shows a transfer energy activator of the present embodiment that uses acoustic vibrations. In the case intermediate object 7 is made of a comparatively light rigid body, temporarily adhered powder 3 can be transferred by air vibrations produced by sound waves emitted from a sound wave generator 15. The above sound wave generator is composed of permanent magnet 16 attached to a cone, and voice coil 15 provided around it. In this case, the above sound wave generator and intermediate object 7 may be spatially separated.

Embodiment 6

The present embodiment relates to electrostatic powder coating for transfer and coating by applying mechanical vibrations to an intermediate object. FIG. 6 shows that in which a thin wire 18 is used for the intermediate object. When tension is applied to this wire 18 by a tension regulator 19, fine mechanical vibrations are induced in wire 18 in the manner of the strings of a musical instrument, making it possible to impart sufficient transfer energy capable of overcoming electrostatic force to the adhered powder 3. Furthermore, a metal instrument string in the manner of a guitar string may also be used instead of thin wire 18.

Embodiment 7

The present embodiment uses a scraper 5 that differs from the scraper used in the previously mentioned Embodiment 2 and an elastic body for the intermediate object, and is an example of scraping that utilizes the deformation of that elastic body. Namely, powder 3 is adhered to the outer periphery of a cylinder 20 made of an elastic material such as rubber, scraper 21 moves inside this cylinder 20, and cylinder 20 is locally expanded (by pressing from the inside) to impart transfer energy to powder 3. Although powder 3 adheres to the surface of cylinder 20 by electrostatic induction due to its own charge, when elastic deformation occurs in cylinder 20, the balance of the electrostatic induction is disturbed resulting in the imparting of transfer energy. The use of elastic deformation offers the advantage of being able to avoid the problem of powder 3 becoming jammed in the boundary between intermediate object 7 and scraper 5 that occurs in the case of scraper 5 in Embodiment 2.

Embodiment 8

FIG. 8 shows an example of a transfer energy activator of the present embodiment that uses air purging that consumes only a small amount of air. Powder 3 is electrostatically adhered to cylindrical intermediate object 7, and transfer energy is imparted to powder 3 while purging the air with an air purging scraper 22 provided with a slight gap between itself and intermediate object 7. However, the coated object must have a shape that enables the securing of an adequate escape path for air 23.

Since the present invention performs coating using transfer, there are no negative effects of the powder being dispersed or blown off by air. In addition, since a high voltage is not required to be applied, the problem of sparking is also eliminated. In this manner, powder coating can be performed even on objects having shapes that were either coated with difficulty or unable to be coated with the prior art. In addition, since targeted, localized coating can also be performed to a certain extent, soiling of portions that are not desired to be coated is reduced.

What is claimed is:

1. An electrostatic powder coating method using transfer comprising: temporarily adhering a powder onto an intermediate object by static electricity, and then coating a target object to be coated by transferring the powder adhered to the intermediate object.

2. The electrostatic powder coating method using transfer as defined in claim 1 wherein, transfer energy is imparted by applying mechanical vibrations to the powder adhered to the intermediate object.

3. The electrostatic powder coating method using transfer as defined in claim 1 wherein, transfer energy is imparted to the powder adhered to the intermediate object by scraping.

4. The electrostatic powder coating method using transfer as defined in claim 1 wherein, transfer energy is imparted to the powder adhered to the intermediate object by air purging.

5. The electrostatic powder coating method using transfer as defined in claim 1 wherein, transfer energy is imparted by applying acoustic vibrations to the powder adhered to the intermediate object.

6. The electrostatic powder coating method using transfer as defined in claim 1 wherein, an electric field for facilitating transfer of the powder adhered to the intermediate object to the target object to be coated is formed between the intermediate object and the target object to be coated.

7. An electrostatic powder coating apparatus using transfer comprising: an intermediate object, an electrostatic powder coating device that adheres powder to the intermediate object, and a transfer device that coats the powder adhered to the intermediate object onto a target object to be coated.

8. The electrostatic powder coating apparatus using transfer as defined in claim 7 wherein, the transfer device is a mechanical vibration generator.

9. The electrostatic powder coating apparatus using transfer as defined in claim 7 wherein, the transfer device is a scraper.

10. The electrostatic powder coating apparatus using transfer as defined in claim 7 wherein, the transfer device is an air purging scraper.

11. The electrostatic powder coating apparatus using transfer as defined in claim 7 wherein, the transfer device is an acoustic vibration generator.

12. The electrostatic powder coating apparatus using transfer as defined in claim 7 that is provided with an electric field generator for forming an electric field, which facilitates the transfer of powder adhered to the intermediate object to the target object to be coated, between the intermediate object and the target object to be coated.
